(19) United States
(12) Patent Application Publication
(10) Pub. No.: US 2005/0039722 A1
(43) Pub. Date: Feb. 24, 2005

(54) SYSTEM AND METHOD FOR PREDICTIVE UNDER-FUELING AND OVER-FUELING IN A COMBUSTION ENGINE

(76) Inventors: David T. Montgomery, Pleasant Prairie, WI (US); Martin L. Radue, Kenosha, WI (US); Scott A. Koerner, Kenosha, WI (US)

Correspondence Address: BOMBARDIER RECREATIONAL PRODUCTS INC.;INTELLECTUAL PROPERTY DEPT, PO BOX 230, NORTON, VT, 05907-0230, US

(21) Appl. No.: 10/605,709

(22) Filed: Oct. 21, 2003

Related U.S. Application Data
(60) Provisional application No. 60/481,259, filed on Aug. 19, 2003.

(51) Int. Cl. F02D 41/14

(52) U.S. Cl. 123/435; 123/436; 123/676

(57) ABSTRACT

A system and method for operating a two-stroke engine that includes at least one cylinder, a piston reciprocally disposed therein, and a scavenging port for egress of exhaust gasses therefrom. A charge purity detector is in operable association with the at least one cylinder to detect irregular combustion in the at least one cylinder. An ECU is connected to receive signals from the charge purity detector and programmed to adjust a charge parameter in a next cycle in response to detected irregular combustion.

### CROSS REFERENCE TO RELATED APPLICATIONS

The present invention claims the benefit of U.S. Ser. No. 60/481,259 filed Aug. 19, 2003.

### BACKGROUND OF INVENTION

The present invention relates generally to internal combustion engines, and more particularly, to a system and method of predicting when over-fueling or under-fueling a combustion chamber will optimize combustion within a combustion chamber of the internal combustion engine. Specifically, charge purity is detected to determine when a subsequent combustion cycle could benefit from over-fueling or under-fueling.

In general, fuel-injected engines include a fuel injector that provides a fine mist of fuel that mixes with combustion generating gases, known as a charge, that generally comprise a mixture of fresh air and any remaining exhaust gases, within a cylinder. This mixture is compressed by a reciprocating piston and spark ignited by a spark plug. The spark plug is essentially a pair of electrodes disposed within a combustion chamber and separated by an air gap. One spark plug electrode is connected to an intermittent voltage potential and the other is connected to an electrical ground. When a sufficient voltage potential is present at one electrode, a spark occurs across the air gap. This well-known construction will be utilized in a unique way in accordance with one embodiment of the invention.

The spark from the spark plug causes the fuel and air mixture to ignite and combustion to occur. The combustion causes the piston to reciprocate. In a two-stroke engine, as the piston is driven downward in the cylinder, two ports in the cylinder wall are opened by the passing of the piston. Due to a pressure differential and the downward travel of the piston within the combustion chamber, the opening of the ports allows the exhaust from the combustion to be pushed out an exhaust port and then fresh air to be drawn into the combustion chamber to replace the exhaust.

The gas exchange, or “scavenging”, process is defined and optimized by two basic criteria. The first involves creation of a pressure differential between the combustion chamber and crankcase, and the second is what is known as exhaust “plugging.” The two are not directly dependent on one another, but both need optimization to create an efficient engine. That is, the higher the pressure differential between the crankcase and the combustion chamber, the more air that can be scavenged into the cylinder. Similarly, the better the timing of an exhaust “plug,” the more of that fresh air can be kept in the cylinder for combustion in the next cycle.

Specifically, during the down stroke, or “power” stroke, of the piston, a pressure differential is created between the combustion chamber and the crankcase. As the piston continues downward, the exhaust and intake ports are uncovered. Replacing the exhaust with fresh air begins after the transfer ports are opened. During this process, the pressure in the combustion chamber is decreased to “scavenge” fresh air from the crankcase into the combustion chamber. Therefore, the higher the pressure differential, the more efficient the scavenging process.

To better understand “plugging”, it is useful to understand how the exhaust travels when exiting the combustion chamber. When the exhaust is forced from the combustion chamber into an exhaust system, the exhaust travels through the exhaust system as an exhaust pulse. In a tuned exhaust, when this exhaust pulse reaches the end of the exhaust system, a high pressure pulse is reflected back to the exhaust port of the combustion chamber as a “plugging” pulse. This plugging pulse pushes or “plugs” fresh charge that escapes through the exhaust port during the scavenging process back into the combustion chamber and effectively “plugs” the port. In this embodiment, the combustion chamber “self-plugs” because the plugging pulse is generated from the reflection of the exhaust pulse that originated from the very same combustion chamber. Therefore, a subsequent combustion cycle is directly affected by the combustion of the previous cycle. For example, poor combustion in one combustion cycle will likely produce a poor plugging pulse, or a badly timed pulse, and result in less fresh charge in the subsequent combustion cycle.

Alternatively, “cross-plugging” is utilized in a multi-cylinder engine, and in particular, three cylinder engines, where the timing of a plugging pulse from one combustion chamber can be set to coincide with the scavenging of another combustion chamber. By tuning the exhaust system of the engine, the exhaust pulse of one cylinder can serve as the plugging pulse of another cylinder. As a result, combustion in one cylinder can directly affect the subsequent combustion cycle of another cylinder if a poor plugging pulse is produced from the first cylinder.

Whether self-plugging or cross-plugging, a predetermined quantity of fuel is typically delivered to the combustion chamber based on operating conditions and demands. This predetermined quantity of fuel is also based on an assumption that the exact timing of combustion will fall within a very specific time window to deliver optimal power to the engine and generate optimal scavenging and plugging pulses. However, it is possible for the exact timing of combustion to fall outside the specific time window for any given combustion. Slow combustion and misfiring may occur when the timing of combustion is not within the window, resulting in operational fluctuations that affect the plugging pulse and/or the cylinder/crankcase pressure differential.

For example, if combustion occurs late in the combustion cycle, the exhaust gases will be hotter when exiting the cylinder. The slow combustion does not deliver optimal energy to drive the engine but does result in an improved scavenging for the next cycle. As a result, more fresh air is present in the combustion chamber. This higher concentration of oxygen, expressed as a higher charge purity, provides for improved combustion in the subsequent combustion cycle. However, since the quantity of fuel injected into the combustion chamber is based on a predetermined charge purity, the improved charge purity is not utilized. That is, no improved operation is gained from the improved charge purity because the combustion is limited by the quantity of fuel injected into the combustion chamber.

On the other hand, should a misfire occur in the combustion chamber, scavenging is diminished and little or no plugging pulse is generated. Accordingly, a diminished charge purity is present in the combustion chamber during the subsequent combustion cycle. That is, in the absence of combustion, the desired pressure differential is not achieved between the combustion chamber and the crankcase. As such, less fresh charge is scavenged during the scavenging period. Furthermore, without a plugging pulse, the charge purity of the next cycle is decreased because some fresh charge that was scavenged is lost via the exhaust system rather than pushed back into the combustion chamber with a proper plugging pulse. Therefore, the concentration of fresh air in the combustion chamber is insufficient to allow optimal combustion of the predetermined quantity of fuel that is injected. As such, unburned fuel remains after combustion and is dispelled through the exhaust system. This results in inefficient engine operation, higher fuel consumption, and higher exhaust emissions.

It would therefore be desirable to have a system and method to determine the charge purity within a combustion chamber and augment the quantity of fuel injected into the combustion chamber in response.

### BRIEF DESCRIPTION OF INVENTION

The present invention relates generally to a system and method of controlling fuel delivery within the combustion chamber that overcomes the aforementioned drawbacks. Specifically, the present invention is a system and method of providing over-fueling or under-fueling such that the quantity of fuel delivered to the combustion chamber during a subsequent combustion cycle is optimized for the charge purity within the combustion chamber from a previous combustion. More specifically, apparatus is implemented to sense combustion conditions and identify atypical engine operation. The combustion conditions are utilized to determine if a subsequent combustion cycle could benefit from over-fueling or under-fueling.

In accordance with one aspect of the current invention, a system and method for operating a two-stroke engine is disclosed that includes at least one cylinder, a piston reciprocally disposed therein, and a scavenging port for egress of exhaust gasses therefrom. A charge purity detector is in operable association with the at least one cylinder to detect irregular combustion in the at least one cylinder. An ECU is connected to receive signals from the charge purity detector and programmed to adjust a charge parameter in a next cycle in response to detected irregular combustion.

In accordance with another aspect of the current invention, a method of controlling fuel injection within a combustion engine is disclosed that includes receiving an electronic signal indicative of combustion thoroughness in at least one cylinder of an engine and determining, from the electronic signal, whether the combustion in the at least one cylinder was regular or irregular. If irregular, the method includes adjusting an operating parameter for a next combustion to compensate for irregular combustion.

In accordance with another aspect of the current invention, an outboard motor is disclosed that includes a powerhead having a combustion engine, a midsection configured for mounting the outboard motor to a watercraft, and a lower unit powered by the engine to propel a watercraft. At least one combustion condition monitor is included to monitor at least one cylinder of the combustion engine. An ECU receives feedback from the combustion condition monitor and is configured to adjust an operating parameter in a next combustion cycle if the feedback from the combustion condition monitor is indicative of atypical combustion.

In accordance with yet another aspect of the current invention, a system for adjusting a fuel quantity delivered to a combustion chamber of an engine is disclosed that includes a means for determining a charge purity within a combustion chamber and a means for adjusting a quantity of fuel delivered during a next combustion cycle according to the charge purity.

Various other features, objects and advantages of the present invention will be made apparent from the following detailed description and the drawings.

### BRIEF DESCRIPTION OF DRAWINGS

The drawings illustrate one preferred embodiment presently contemplated for carrying out the invention.

In the drawings:

FIG. 1 is an outboard marine engine incorporating the present invention.

FIG. 2 is a cross-sectional view of an engine cylinder of the engine shown in FIG. 1 having means for determining charge purity.

FIG. 3 is a flow chart setting forth the steps of a process for ion gap sensing within the engine shown in FIG. 1.

### DETAILED DESCRIPTION

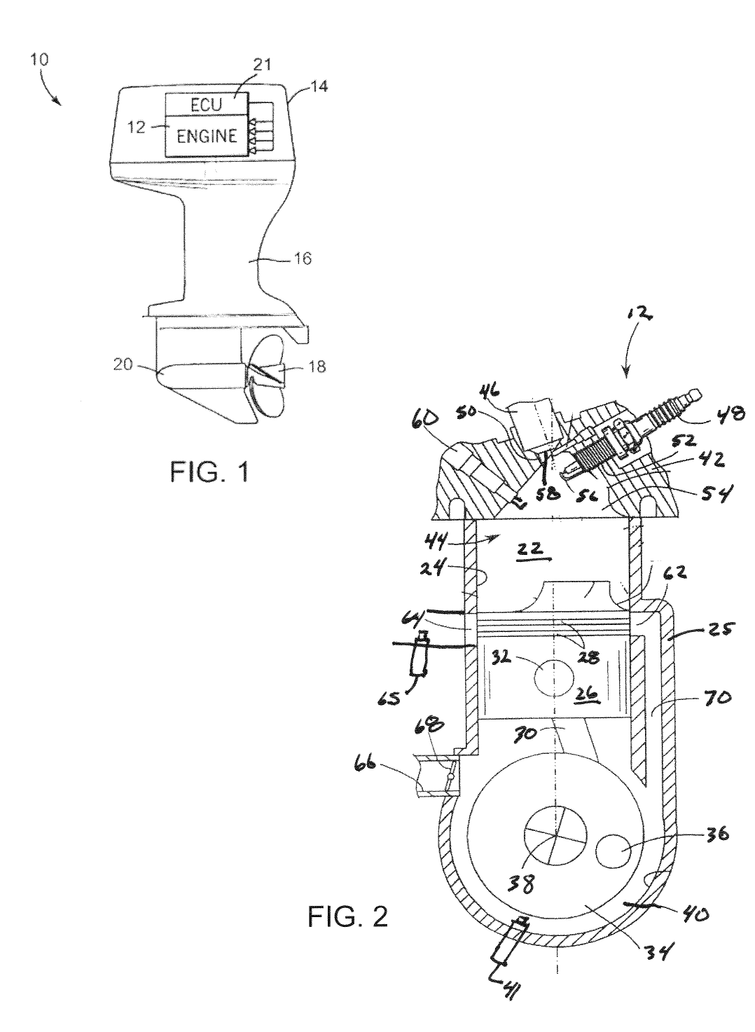

The present invention relates to internal combustion engines, and preferably, those incorporating direct fuel injection in a spark-ignited gasoline-type engine. In a preferred embodiment, the engine is a two-stroke direct injected engine. FIG. 1 shows an outboard motor 10 having one such engine 12. The engine 12 is housed in a powerhead 14 and supported on a mid-section 16 configured for mounting on the transom of a boat (not shown) in a known conventional manner. An output shaft of the engine 12 is coupled to a drive propeller 18 extending rearwardly of a lower gearcase 20 via the mid-section 16. The engine 12 is controlled by an electronic control unit (ECU) 21. While the invention is shown in FIG. 1 as being incorporated into an outboard motor, the present invention is equally applicable with many other recreational products such as inboard motors, motorcycles, scooters, snowmobiles, personal watercrafts, all terrain vehicles, and lawncare equipment.

Referring to FIG. 2, an exemplary individual engine cylinder 22 of engine 12 is shown in cross-section. The cylinder 22 includes a cylinder bore 24 in an engine block 25 through which a piston 26 reciprocates. The piston 26 typically includes one or more rings 28 to create a seal between the piston 16 and the cylinder bore 24 as the piston 26 reciprocates within the cylinder 22. The piston 26 is coupled to a rod 30 by a pin 32. The rod 30 is connected to a crankshaft 34 at a position 36 offset from a center 38 of the crankshaft 34. The crankshaft 34 is rotated as the piston 26 reciprocates. Specifically, the crankshaft rotates about the center of the crankshaft 38 in a crankcase 40, as the piston 26 reciprocates.

In accordance with a preferred embodiment, a crankshaft velocity monitor 41 is disposed within the crankcase 40 to provide feedback on variations in the velocity of the crankshaft 38. As will be further described, while the crankshaft velocity monitor 41 is shown disposed within the crankcase 40, it is contemplated that the crankshaft velocity monitor 41 may be disposed in any position within the engine 22 where the rotational velocity of the crankshaft 38 can be monitored.

A cylinder head 42 is mounted to the engine block 25 to enclose cylinder 22 and define a combustion chamber 44.

Mounted within the cylinder head 42 is a fuel injector 46 to deliver fuel directly into the combustion chamber 42. Also mounted within the cylinder head 42 is a spark plug 48 to ignite a fuel-air mixture in the combustion chamber 44. The fuel injector 46 and the spark plug 48 are received in openings 50 and 52, respectively, within a recess 54 of the combustion chamber 44.

A pair of electrodes 56 of the spark plug 48 extends near an injection nozzle 58 of the fuel injector 46. In accordance with one embodiment, and as will be further described, an auxiliary pair of electrodes 60 to perform ion gap sensing is positioned in communication with the combustion chamber 44 within the recessed region 54. However, in an alternative embodiment, the pair of electrodes 56 of spark plug 48 may be used to perform ion gap sensing, in which case the auxiliary pair of electrodes 60 is not needed.

The cylinder 22 includes an intake port 62 and an exhaust port 64. In accordance with a preferred embodiment, an exhaust gas temperature monitor 65 is disposed in the exhaust port 64 to monitor exhaust gas temperature. As will be described, it is contemplated that the exhaust gas temperature monitor 65 may also be disposed within the exhaust system (not shown) or at any other position where the exhaust gas temperature monitor 65 is exposed to gases exhausting from the combustion chamber 44.

When the piston 26 travels downwardly and exhausts gases through exhaust port 64 from combustion chamber 44, a fresh charge is drawn into cylinder 22 through an intake port 62. When the piston 26 travels towards the cylinder head 42 to compress the charge of air within the combustion chamber 44, a fresh charge of air is also drawn into crankcase 40 through an inlet port 62. A reed valve 68 allows the air to pass into crankcase 40 but prevents escape back through inlet port 66 on the power stroke.

At the start of the combustion stroke, near a top-dead-center position of piston 26, when the fresh air charge is compressed, the fuel injector 46 injects fuel to create a fuel-air mixture that is ignited by a spark between the pair of electrodes 56. Upon ignition of the fuel-air charge in the combustion chamber 44, the piston 26 is driven away from the cylinder head 42 past the exhaust port 64 through which the exhaust gasses are discharged. The creation of a pressure differential between the combustion chamber 44 and the crankcase 40 forces the exhaust gases out the exhaust port 64 and travel through an exhaust system. As the piston 26 moves past the exhaust port 64, the intake port 62 is fully opened and a fresh charge is scavenged through the intake port 62 to replace the exhaust gases leaving the combustion chamber 44. More specifically, the downward travel of piston 26 compresses the air surrounding the crankshaft 34 in crankcase 40 and forces the fresh charge in the crankcase 40 into the combustion chamber 44 through the scavenge port 62 for mixing with the next injection of fuel to be ignited by spark plug 48.

However, some of the fresh charge may be expelled through the exhaust port 64 and into the exhaust system. As such, prior to closing the exhaust port 64, a plugging pulse, either from a reflection of the cylinder's exhaust pulse or from reflection of an exhaust pulse of an adjacent cylinder, plugs the expelled fresh charge as the exhaust port 64 closes, and preferably, actually pushes the escaped fresh charge back into the combustion chamber.

During the combustion cycle, a plurality of detection devices, or charge purity monitors, detect combustion thoroughness. Specifically, the pair of electrodes 56 or 60, the crankshaft velocity monitor 41, and the exhaust gas temperature monitor 65, or any combination thereof, are means for monitoring the combustion cycle for a combustion condition.

More specifically, the pair of electrodes monitor conductivity by performing ion gap sensing to determine the concentration of ionized gases within the combustion chamber 44 as an indication of combustion thoroughness. Ion gap sensing is accomplished by placing a voltage potential across the electrodes 56 or 60 and measuring the current that flows between the electrodes 56 or 60. Under a voltage potential, the current that flows between the electrodes 56 or 60 is proportional to the conductivity of the gas in the combustion chamber 44. The gas conductivity is indicative of the ionization of the combustion gas because the ions are responsible for the transportation of the charge across the gap between the electrodes 56 or 60.

The ions are produced from two sources, both of which are indicative of combustion. First, the molecules of the injected fuel are broken up due to the forced molecular interactions during combustion. These interactions induce ionization of the fuel molecule “fragments.” Second, the high thermal conditions associated with combustion cause thermal ionization of the gases present in the combustion chamber 44 during combustion. Therefore, combustion results in an increase in ions within the combustion chamber 44. In the present invention, ion gap sensing is performed over the duration of the combustion cycle to determine the specific timing of combustion within the combustion cycle. As will be described, by identifying the timing of combustion, a combustion condition can be detected and the charge purity for the subsequent combustion cycle can be determined.

By monitoring the conductivity within the combustion chamber 44 during the previous combustion cycle, the ECU 21, FIG. 1, can therefore determine the charge purity within the combustion chamber 44 of FIG. 2, during a next combustion cycle and augments the precise amount of fuel injected by fuel injector 46 into the combustion chamber 44 according to the charge purity. As described, by monitoring any combination of combustion condition feedback, the amount of fuel injected can be carefully controlled to match the amount of fresh charge present in the combustion chamber 44 during the next combustion cycle.

Additionally, since combustion within the combustion chamber 44 causes the piston 26 to be driven downward and rotate the crankshaft 38, combustion conditions can be identified from variations in the rotational velocity of the crankshaft 38. The crankshaft velocity monitor 41 can be used to detect the rotation of the crankshaft 38, and the ECU 21 can then detect variations in the rotation. Specifically, should a misfire take place within the combustion chamber 44, the crankshaft will not be driven as forcefully by the piston 26, and therefore the instantaneous velocity of the crankshaft 38 will slow. Similarly, should combustion occur late in the combustion cycle, the velocity of the crankshaft 38 will change and then increase later than expected by the eventual force from combustion. As will be described, by identifying variations in the velocity of the crankshaft 38, a combustion condition can be detected and the charge purity of the subsequent combustion cycle can be determined.

Also, the exhaust gas temperature monitor 65 detects variations in the temperature of gases exhausting from the combustion chamber 44 through exhaust port 64. Since the degree of efficient combustion causes the gases contained in the combustion chamber 44 to be heated at differing rates, by monitoring exhaust temperatures, the previous combustion efficiency can be derived by the ECU. Under normal combustion, the temperature of exhausting gases is relatively consistent. However, if combustion is slow or if a misfire occurs, the temperature of the exhausting gases fluctuates. Specifically, if combustion is slow, the exhausting gases are hotter than if normal combustion occurs, and if a misfire occurs, the gases are cooler than if normal combustion occurs. As will be fully described, by identifying variations in the temperature of gases leaving the exhaust port 64, a combustion condition can be detected and the charge purity of the subsequent combustion cycle can be determined.

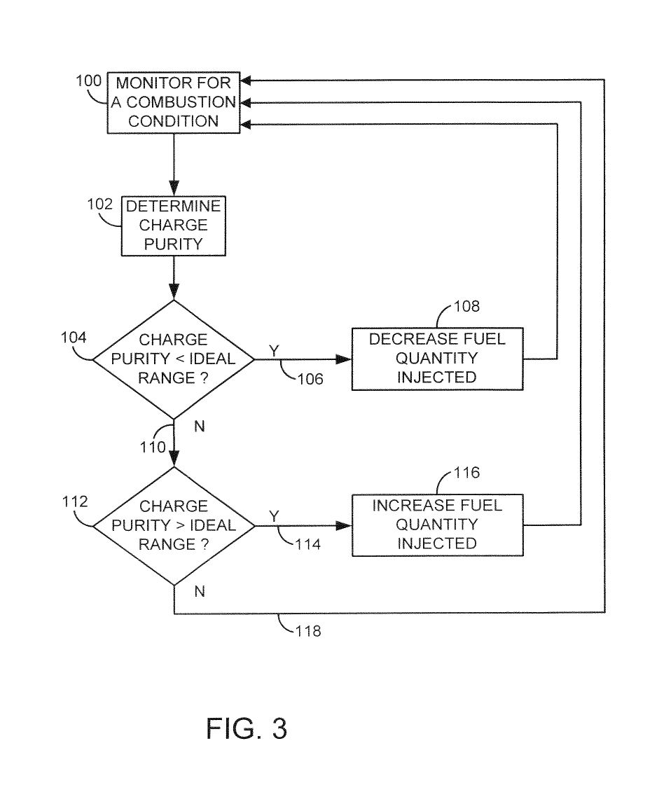

Referring now to FIG. 3, a flow chart sets forth steps/acts of a process/computer program in accordance with the present invention to predict and anticipate a need to either under-fuel or over-fuel a next combustion cycle on a cylinder-by-cylinder basis. As set forth, combustion conditions are initially monitored 100. A combustion chamber charge purity is determined 102 by analyzing variations in crankshaft velocity, variations in exhaust temperature, ion gap sensing, or any combination thereof. The charge purity determined at 102 is associated with the cylinder being monitored, which may or may not be the same cylinder in which adjustments will be made to compensate for an atypical charge purity. Specifically, if the engine configuration is such that the plugging pulse reflection is delivered to the same cylinder (i.e. self-plugging), the charge purity is associated with the same cylinder to be adjusted. However, if the engine is configured such that the exhaust pulse reflection of one cylinder provides the plugging pulse for another cylinder (i.e. cross-plugging), the adjustment is made to a cylinder different from where the charge purity is detected.

Once the charge purity is determined 102, the ECU determines whether the charge purity is other than ideal. The ideal range is a range of charge purities that are indicative of normal combustion. In one embodiment, the ECU first checks if the charge purity is less than an ideal range 104, and if the determined charge purity is less than the ideal range 104, 106, the ECU determines that the received feedback signal indicates an atypical combustion condition, for example slow combustion or a misfire, and therefore decreased scavenging and/or incorrect plugging is expected in a next cycle. For example, if ions indicative of combustion are not detected during the monitoring of the combustion cycle 100, a misfire has occurred and a decreased charge purity is expected. That is, if the combustion condition detected is indicative of a misfire, such as an absence of an induced current across the electrodes, or the presence of a low induced current when ion gap sensing, and/or a decrease in crankshaft velocity, and/or a low exhaust temperature, a low charge purity constituting a low concentration of oxygen is presumed because a reduced or mis-timed plugging pulse is expected and scavenging is decreased.

If the decreased charge purity is less than an ideal charge purity range 104, 106, the fuel quantity injected during the next combustion cycle is decreased 108. As a result, the injected fuel quantity corresponds to the charge purity for efficient, clean combustion and combustion is again monitored to detect indicia of irregular combustion 100.

However, if the determined charge purity is not less than the ideal range 104, 110, the ECU determines whether the charge purity is greater than the ideal range 112, and if the determined charge purity is greater than the ideal range 112, 114, increased scavenging and incorrect plugging is expected resulting in a higher concentration of oxygen in the combustion chamber during the next combustion cycle. For example, if ions indicative of combustion are detected late in the combustion cycle during the monitoring of the combustion cycle 100, a slow combustion has occurred and an increased charge purity is expected for the next cycle. Specifically, if a combustion condition is detected that indicates combustion occurred late in the combustion cycle, a high charge purity is expected. That is, if an electrical ionization current across the electrodes is indicative of late combustion in the combustion cycle, or a crankshaft velocity is indicative of late combustion, or if the exhaust temperature is higher than would be produced by normal combustion, a combustion condition indicative of slow combustion is presumed. Under such conditions, improved scavenging is expected and a higher charge purity constituting a high concentration of oxygen is expected for the next combustion cycle.

If the detected charge purity is greater than an ideal charge purity range 112, 114, the fuel quantity injected during the subsequent combustion cycle is increased according to the magnitude of increase in detected charge purity 116. As a result, the injected fuel quantity corresponds to the charge purity, yielding improved combustion in the subsequent combustion cycle, during which combustion is again monitored to detect indicia of irregular combustion 100.

If the detected charge purity is neither less than the ideal range 106 nor greater than the ideal range 114, the detected combustion condition is indicative of normal combustion 118. Therefore, the quantity of fuel is not changed and the predetermined fuel quantity corresponding to normal combustion is delivered to the combustion chamber during the subsequent combustion cycle.

Accordingly, a technique is provided such that the amount of fuel injected into the combustion chamber corresponds to a detected charge purity of a combustion chamber. Combustion conditions are detected and an associated charge purity is determined. The determined charge purity is an indication of the concentration of oxygen in the combustion chamber during the next combustion cycle and is utilized to supply an over-fueling, an under-fueling, or a normal fueling to a given combustion chamber in the next combustion cycle, thereby optimizing engine operation.

It is contemplated that the above-described technique be embodied in a system and method for operating a two-stroke engine that includes at least one cylinder, a piston reciprocally disposed therein, and a scavenging port for egress of exhaust gasses therefrom. A charge purity detector is in operable association with the at least one cylinder to detect irregular combustion in the at least one cylinder. An ECU is connected to receive signals from the charge purity detector and programmed to adjust a charge parameter in a next cycle in response to a detected irregular combustion. The two-stroke engine may be incorporated into any one of an outboard motor, inboard motor, motorcycle, scooter, snowmobile, personal watercraft, all-terrain vehicle, lawn-care equipment, or any device requiring its own power source.

It is further contemplated that the above-described technique be embodied in a method of controlling fuel injection within a combustion engine that includes receiving an electronic signal indicative of combustion thoroughness in at least one cylinder of an engine and determining, from the electronic signal, whether the combustion in the at least one cylinder was regular or irregular. If irregular, the method includes adjusting an operating parameter for a next combustion to compensate for irregular combustion.

It is also contemplated that the above-described technique be embodied in an outboard motor that includes a powerhead having a combustion engine, a midsection configured for mounting the outboard motor to a watercraft, and a lower unit powered by the engine to propel a watercraft. At least one combustion condition monitor is included to monitor at least one cylinder of the combustion engine. An ECU receives feedback from the combustion condition monitor and is configured to adjust an operating parameter in a next combustion cycle if the feedback from the combustion condition monitor is indicative of atypical combustion.

It is also contemplated that the above-described technique be embodied in a system for adjusting a fuel quantity delivered to a combustion chamber of an engine that includes a means for determining a charge purity within a combustion chamber and a means for adjusting a quantity of fuel delivered during a next combustion cycle according to the charge purity. The means for determining charge purity can be any of the charge purity detectors disclosed, or a combination of any of these, or any other technique to determine charge purity. The means for adjusting fuel can include the aforementioned ECU having a programmed microprocessor, or computer, a discrete circuit, or any other processing or memory map technique.

The present invention has been described in terms of the preferred embodiment, and it is recognized that equivalents, alternatives, and modifications, aside from those expressly stated, are possible and within the scope of the appending claims.

1-27. (Canceled)

28. An outboard motor comprising:
a powerhead having a combustion engine, a midsection configured for mounting the outboard motor to a watercraft, and a lower unit powered by the engine to propel a watercraft;
at least one combustion monitor to monitor at least one cylinder of the combustion engine; and
an ECU to receive feedback from the combustion condition monitor and configured to adjust an operating parameter in a next combustion cycle if the feedback from the combustion condition monitor is indicative of atypical combustion.

29. The outboard motor of claim 28 wherein the combustion condition monitor is configured to determine an oxygen concentration in the at least one cylinder during the next combustion cycle.

30. The outboard motor of claim 29 wherein the ECU is configured to deliver an over-fueling quantity of fuel in the next combustion cycle if the oxygen concentration in the next combustion cycle is higher than expected.

31. The outboard motor of claim 29 wherein the ECU is configured to deliver an under-fueling quantity of fuel in the next combustion cycle if the oxygen concentration in the next combustion cycle is lower than expected.

32. The outboard motor of claim 28 wherein the atypical combustion is detected by monitoring at least one of a conductivity within the at least one cylinder, a variation in crankshaft velocity, and a variation in exhaust gas temperature.

33. The outboard motor of claim 28 wherein the operating parameter adjusted is a fuel quantity of the at least one cylinder.

34. The outboard motor of claim 28 wherein the operating parameter adjusted is a fuel quantity of another cylinder of the combustion engine.

35.-40. (Canceled)
